(19) United States
(12) Patent Application Publication
(10) Pub. No.: US 2011/0296257 A1
(43) Pub. Date: Dec. 1, 2011

(54) POST CARD

(75) Inventor: ZHAO-JIE CAO, Shenzhen City (CN)

(73) Assignees: HON HAI PRECISION INDUSTRY CO., LTD., Tu-Cheng (TW); HONG FU JIN PRECISION INDUSTRY (SHENZHEN) CO., LTD., Shenzhen City (CN)

(21) Appl. No.: 12/835,706

(22) Filed: Jul. 13, 2010

(30) Foreign Application Priority Data
Jun. 1, 2010 (CN) 201010188649.2

(51) Int. Cl. G06F 11/07; G06F 15/177

(52) U.S. Cl. 714/57; 713/2; 714/E11.023

(57) ABSTRACT

A POST card includes a PCI connector, an LPC connector, a controller, and an indicating module. The controller includes a PCI decoder, an LPC decoder, a multiplexer, and a driver. The POST card connects to and reads error codes from a computer motherboard by the PCI connector or the LPC connector depending on which type of interface the computer motherboard has. The PCI decoder is activated and decodes the error codes read through the PCI connector. The LPC decoder is activated and decodes the error codes read through the LPC connector. The multiplexer connects the driver to the PCI decoder or the LPC decoder to transmit the error code to the driver depending on which one of the PCI connector and the LPC connector is connected to the computer motherboard. The driver drives the indicating module to display the error codes.

### BACKGROUND

1. Technical Field

The present disclosure relates to a post-on self-test (POST) card.

2. Description of Related Art

Current POST cards typically have only one connector and thus can only connect to computer motherboards that include an interface matching the connector. For example, a POST card only having a peripheral component interconnect (PCI) connector can only connect to computer motherboards having a PCI interface and is not available for other computer motherboards.

Therefore, it is desirable to provide a POST card which can overcome the above-mentioned limitations.

### BRIEF DESCRIPTION OF THE DRAWINGS

Many aspects of the present POST card should be better understood with reference to the following drawings. The components in the drawings are not necessarily drawn to scale, the emphasis instead being placed upon clearly illustrating the principles of the present POST card. Moreover, in the drawings, like reference numerals designate corresponding parts throughout the views.

FIG. 1 is a schematic view of a POST card and a computer motherboard, according to an embodiment.

FIG. 2 is a functional block diagram of a controller of the POST card of FIG. 1.

### DETAILED DESCRIPTION

Embodiments of the present POST card will now be described in detail with reference to the drawings.

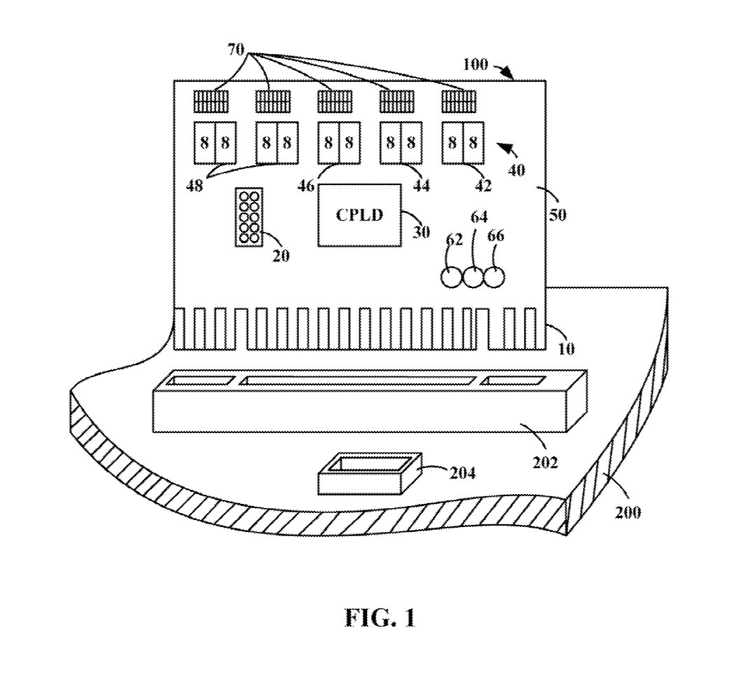

Referring to FIG. 1, a POST card 100, according to an embodiment, includes a PCI connector 10, a low pin count (LPC) connector 20, a controller 30, an indicating module 40, a printed circuit board (PCB) 50, three light emitting diodes (LEDs) 62, 64, and 66, and a set of Boolean switches 70.

The PCI connector 10 is configured for connecting the POST board 100 to a computer motherboard (not shown) to be diagnosed thereby having a PCI interface (not shown) to read error codes generated by the computer motherboard. The LPC connector 20 is configured for connecting the POST board 100 to a computer motherboard (not shown) to be diagnosed thereby having an LPC interface (not shown) to read error codes generated by the computer motherboard. The controller 30 is configured for controlling the indicating module 40 to indicate the error codes from the PCI connector 10 or the LPC connector 20. The PCB 50 is configured for mounting the PCI connector 10, the LPC connector 20, the controller 30, the indication module 40, the LEDs 62, 64, and 66, and the set of Boolean switches 70. The LEDs 62, 64, and 66 is configured for indicating whether or not a computer motherboard to be diagnosed by the POST card 100 is powered on properly or a connection between the POST card 100 and the computer motherboard is established properly. The set of Boolean switches 70 is configured for setting a certain address of a memory of a computer motherboard to be diagnosed by the POST card 100.

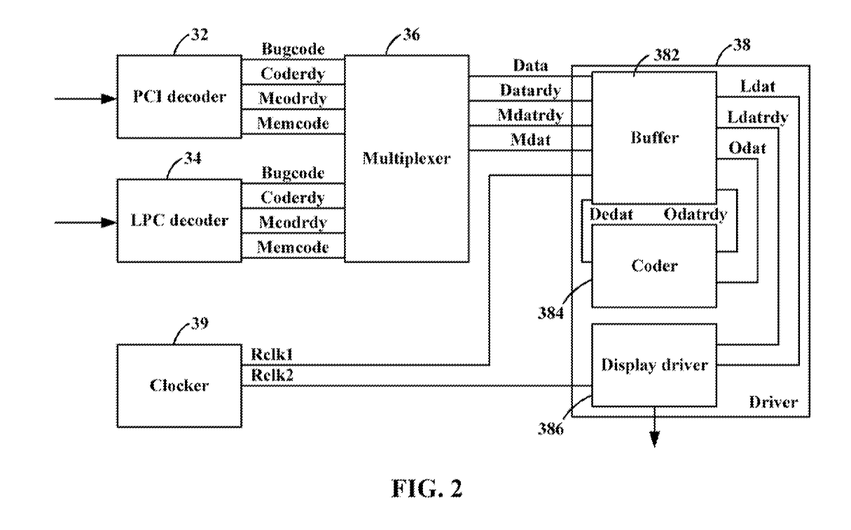

Also referring to FIG. 2, the controller 30, such as a complex programmable logic device (CPLD), includes a PCI decoder 32, an LPC decoder 34, a multiplexer 36, a driver 38, and a clocker 39. The PCI decoder 32 is configured for decoding the error codes when the POST card 100 reads the error codes through the PCI connector 10 so that the decoded error codes are processible by certain parts of the controller 30. The LPC decoder 34 is configured for decoding the error codes when the POST card 100 reads the error codes through the LPC connector 20 so that the decoded error codes are processible by certain parts of the controller 30. The multiplexer 36 is configured for connecting the driver 38 to the PCI decoder 32 or the LPC decoder 34, depending on which one of the PCI decoder 32 and the LPC decoder 34 the error codes are read. The driver 38 is configured for driving the indicating module 40 to indicate the error codes. The clocker 39 is configured for generating clock signals such that the controller 30 can work based on the clock signals.

The driver 38 includes a buffer 382, a coder 384, and a display driver 386. The buffer 382 is configured for temporarily storing the decoded error codes from the PCI decoder 32 or the LPC decoder 34. The coder 384 is configured for recoding the decoded error codes so that the recoded error codes are processible by the display driver 386. The display driver 386 is configured for driving the indicating module 40 to display the error codes.

The indicating module 40 includes a first display 42, a second display 44, a third display 46, each of which includes two seven-segment displays, and a fourth display 48 that includes four seven-segment displays. The displays 42, 44, 46 are configured for displaying the error codes when the PCI connector 10 or the LPC connector 20 are ports 80, 84, and 85, respectively. The fourth display 48 is configured for display the content of the certain address of the memory of the computer motherboard, which is set by the Boolean switches 70.

In assembly, the PCI connector 10, the LPC connector 20, the controller 30, the indication module 40, the LEDs 62, 64, and 66, and the set of Boolean switches 70 are mounted on the PCB 50 and interconnected through circuits (not shown) formed in the PCB 50. The PCI connector 10 has golden fingers formed at an edge of the PCB 50.

If the computer motherboard to be diagnosed thereby only has a PCI interface, the POST card 100 can connect to the computer motherboard by inserting the PCI connector 10 into the PCI interface. If the computer motherboard only has an LPC interface, the POST card 100 can connect to the computer motherboard by inserting the LPC connector 20 into the LPC interface. In this embodiment, a computer motherboard 200 to be diagnosed by the POST card 100 includes both a PCI interface 202 and an LPC interface 204. Therefore, the POST card 100 can connect to the computer motherboard 200 by either the PCI connector 10 or the LPC connector 20.

Both the PCI decoder 32 and the LPC decoder 34 connects to the multiplexer 36 through a first data channel Bugcode, a first data ready channel Coderdy, a first memory data channel Memdat, and a first memory data ready channel Mdatrdy. The first data channel Bugcode is configured for transmitting the decoded error codes from the PCI decoder 32 or the LPC decoder 34 to the multiplexer 36. The first data ready channel Coderdy is configured for sending a data transmission request from the PCI decoder 32 or the LPC decoder 34 to the multiplexer 36. The first memory data channel Memdat is configured for transmitting the content of the memory from the PCI decoder 32 or the LPC decoder 34 to the multiplexer 36. The first memory data ready channel Mdatrdy is configured for transmitting a data transmission request from the PCI decoder 32 or the LPC decoder 34 to the multiplexer 36.

The buffer 382 and the multiplexer 36 form a second data channel Data, a second data ready channel Datardy, a second memory data channel Mdat, and a second memory data ready channel Mdatrdy. The second data channel Data is configured for transmitting the decoded error codes from the multiplexer 36 to the buffer 382. The second data ready channel Datardy is configured for transmitting a data transmission request from the multiplexer 36 to the buffer 382. The second memory data channel Mdat is configured for transmitting the content of the memory from the multiplexer 36 to the buffer 382. The second memory data ready channel Mdatrdy is configured for transmitting a data transmission request from the multiplexer 36 to the buffer 382.

The coder 384 and the buffer 382 form a third data channel Odat, a third data ready channel Odatrdy, and a fourth data channel Dedat. The third data channel Odat is configured for transmitting the decoded error codes from the buffer 382 to the coder 384. The third data ready channel Odatrdy is configured for transmitting a data transmission request from the buffer 382 to the coder 384. The fourth data channel Dedat is configured for transmitting the recoded error codes from the coder 384 back to the buffer 382. Therefore, the buffer 382 is also configured for temporarily storing the recoded error codes from the coder 384.

The buffer 382 and the display driver 386 form a fifth data channel Ldat and a fourth data ready channel Ldatrdy. The fifth data channel Ldat is configured for transmitting the recoded error codes from the buffer 382 to the display driver 386. The fourth data ready channel Ldatrdy is configured for transmitting a data transmission request from the buffer 382 to the display driver 386.

The three LEDs 62, 64, and 66 connect three respective power terminals (e.g., 5V, 3.3V, and 1.5V) of the PCI connector 10 to the ground terminal of the PCI connector 10. The LED 64 connects a power terminal (e.g., 3.3V) of the LPC connector 20 to the ground terminal of the LPC connector 20.

In use, when the computer motherboard 200 is powered on, a basic input output system (BIOS) chip (not shown) of the computer motherboard 200 starts running a POST sequence to test whether or not all peripheral components (not shown) installed to the computer motherboard 200 work properly. If a specific peripheral component does not work properly, the BIOS chip stops running the POST sequence and reports a physical address of the specific peripheral component as error codes to the PCI interface 202 and the LPC interface 204. Then, the POST card 100 can read the error codes through the PCI connector 10 or the LPC connector 20.

If the POST card 100 connects to the computer motherboard 200 through the PCI connector 10 and the computer motherboard 200 is powered on, all three LEDs 62, 64, and 66 should be turned on. Otherwise, it can be determined that the computer motherboard 200 is not properly powered on or the connection between the POST card 100 and the computer motherboard 200 is not properly established. If the POST card 100 connects to the computer motherboard 200 through the LPC connector 20 and the computer motherboard 200 is powered on, the LED 64 should be turned on. Otherwise, it can be determined that the computer motherboard 200 is not properly powered on or the connection between the POST card 100 and the computer motherboard 200 is not properly established.

The PCI decoder 32 is activated when the POST card 100 connects to the computer motherboard 200 through the PCI connector 10 and decodes the error codes read from the computer motherboard 200 through the PCI connector 10 or the LPC decoder 34 is activated in case that the POST card 100 connects to the computer motherboard 200 through the LPC connector 20 and decodes the error codes read from the computer motherboard 200 through the LPC connector 20. In detail, the error codes from the computer motherboard 200 are typically digital codes and may not be processible by certain elements of the controller 30, such as the multiplexer 36 and the driver 38. Therefore, the PCI decoder 32 and the LPC decoder 34 are employed here to decode the error codes into another form that is processible by the controller 30, for example, analog codes. Commonly, each of the PCI decoder 32 and the LPC decoder 34 has a detecting function that detects whether or not a corresponding connector is connected and is activated when the corresponding connector is connected.

If the POST card 100 connects to and reads the error codes from the computer motherboard 200 through the PCI connector 10, the PCI decoder 32 decodes the read error codes and sends the data transmission request to the multiplexer 36 through the corresponding first data ready channel Coderdy. The multiplexer 36 starts reading the decoded error codes from the PCI decoder 32 through the corresponding first data channel Bugcode upon receiving the data transmission request from the PCI decoder 32. Similarly, if the POST card 100 connects to and reads the error codes from the computer motherboard 200 through the PCI connector 10, the LPC decoder 34 decodes the read error codes and sends the data transmission request to the multiplexer 36 through the corresponding first data ready channel Coderdy. The multiplexer 36 starts reading the decoded error codes from the LPC decoder 34 through the corresponding first data channel Bugcode upon receiving the data transmission request from the LPC decoder 34.

The multiplexer 36 sends the data transmission request to the buffer 382 through the second data ready channel Datardy. The buffer 382 starts to read the decoded error codes from the multiplexer 36 through the second data channel Data upon receiving the data transmission request.

The buffer 382 sends the data transmission request to the coder 384 through the third data ready channel Odatrdy. The coder 384 starts reading the decoded error codes from the buffer 382 through the third data channel Odat upon receiving the data transmission request. Since the indicating module 40 is mainly consisted of seven-segment displays which are typically driven by hexadecimal codes, the coder 384 is employed here to recode the decoded error codes into hexadecimal codes. After the error codes are recoded, the coder 384 sends the recoded error codes back to the buffer 382 through the fourth data channel Dedat. The buffer 382 sends the data transmission request to the display driver 384 through the third data ready channel Odatrdy. The coder 384 starts reading the decoded error codes from the buffer 382 through the third data channel Odat upon receiving the data transmission request.

The POST card 100 can apply to almost all current computer motherboards since the PCI interface and LPC interface are the two most common interfaces used in current computer motherboards.

After the computer motherboard 200 is booted up, the set of Boolean switches 70 can set a physical address of the memory and signaling the controller 30 to read the content of the corresponding physical address of the memory and display the content on the fourth display 48 as four hexadecimal digits. As such, the POST card 100 can be used to monitor the memory too.

It will be understood that the above particular embodiments and methods are shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

1. A POST card comprising:
a PCI connector;
an LPC connector; the POST card connecting to and reading error codes from a computer motherboard through the PCI connector or the LPC connector during the time the computer motherboard is booting up;
a controller comprising:
a PCI decoder activated to decode the error codes when the error codes are read from the PCI connector;
an LPC decoder activated to decode the error codes when the error codes are read from the LPC connector;
a multiplexer; and
a driver; the multiplexer being configured for connecting the driver to the PCI decoder or the LPC decoder to transmit the decoded error codes to the driver depending on which one of the PCI decoder and the LPC decoder is activated and decodes the error codes; and
an indicating module; the driver being configured for driving the indicating module to display the error codes.

2. The POST card of claim 1, wherein both the PCI decoder and the LPC decoder communicate with the multiplexer through a first data channel and a first data ready channel, the first data ready channel being configured for transmitting a data transmission request from the PCI decoder or the LPC decoder to the multiplexer after the error codes are decoded, the first data channel being configured for transmitting the decoded error codes from the PCI decoder or the LPC decoder to the multiplexer.

3. The POST card of claim 1, wherein the driver comprises:
a buffer for temporarily storing the decoded error codes;
a coder; and
a display driver for driving the indicating module to display the error codes; the coder being configured for recoding the decoded error codes from the buffer into a new form that is processible by the driver.

4. The POST card of claim 3, wherein the multiplexer communicates with the buffer through a second data channel and a second data ready channel; the second data ready channel being configured for transmitting a data transmission request from the multiplexer to the buffer after the decoded error codes are ready to transmit, the second data channel being configured for transmitting the decoded error codes from the multiplexer to the buffer.

5. The POST card of claim 3, wherein the buffer communicates with the coder through a third data channel, a third data ready channel, and a fourth data channel; the third data ready channel being configured for transmitting a data transmission request from the buffer to the coder after the decoded error codes are ready to transmit, the third data channel being configured for transmitting the decoded error codes from the buffer to the coder; the fourth data channel being configured for transmitting the recoded error codes back to the buffer.

6. The POST card of claim 3, wherein the buffer communicates with the display driver through a fifth data channel and a fourth data ready channel; the fifth data ready channel being configured for transmitting a data transmission request from the buffer to the display driver after the recoded error codes are ready to transmit, the fifth data channel being configured for transmitting the recoded error codes from the buffer to the display driver.

7. The POST card of claim 1, wherein the indicating module comprising three displays for displaying the error codes when the PCI connector or the LPC decoder connects to 80, 84, and 85 ports respectively.

8. The POST card of claim 1, further comprising three light emitting diodes (LEDs); the PCI connector comprising three power source terminals, the LPC connector comprising a power source terminal; the LEDs connect respective power source terminals of the PCI connector to the ground, one of the LEDs connect the power source terminal of the LPC connector to the ground.

9. The POST card of claim 1, further comprising a set of Boolean switches, the Boolean switches being configured for setting a physical address of a memory installed to the computer mother board after the computer motherboard is booted up.

10. The POST card of claim 9, wherein the controller being configured for reading the content of the set physical address of the memory through the PCI connector or the LPC connector depending on which one of the PCI connector and the LPC connector is connected to the computer motherboard.

11. The POST card of claim 9, wherein the PCI decoder and the LPC decoder communicate with multiplexer through a first memory data channel and a first memory data ready channel, the first memory data channel is configured for transmitting the content of the memory from the PCI decoder or the LPC decoder to the multiplexer, the first memory data ready channel is configured for transmitting a data transmission request from the PCI decoder or the LPC decoder to the multiplexer.

12. The POST card of claim 9, wherein the driver comprises a buffer for temporarily storing the content of the memory, the multiplexer communicating with the buffer through a second memory data channel and a second memory data ready channel, the second memory data channel being configured for transmitting the content of the memory from the multiplexer to the buffer, the second memory data ready channel being configured for transmitting a data transmission request from the multiplexer to the buffer.
